(19) United States
(12) Patent Application Publication
(10) Pub. No.: US 2015/0171717 A1
(43) Pub. Date: Jun. 18, 2015

(54) NET SHAPED ALIGNED AND SINTERED MAGNETS BY MODIFIED MIM PROCESSING

(71) Applicant: GM Global Technology Operations LLC, Detroit, MI (US)

(72) Inventors: Shekhar G. Wakade, Grand Blanc, MI (US); Frederick E. Pinkerton, Shelby Township, MI (US)

(73) Assignee: GM Global Technology Operations LLC, Detroit, MI (US)

(21) Appl. No.: 14/109,097

(22) Filed: Dec. 17, 2013

(51) Int. Cl. H02K 15/03; H01F 41/02; H01F 1/057; B22F 3/12; B22F 5/00

(52) U.S. Cl. CPC H02K 15/03; B22F 3/12; B22F 5/00; H01F 1/0577; H01F 41/0266

(57) ABSTRACT

A method of making a permanent magnet and a permanent magnet. The method includes using metal injection molding to mix a magnetic material with a binder into a common feedstock and injection mold the feedstock into a predetermined magnet shape. The injection molding of the feedstock takes place in conjunction with the application of a magnetic field such that at least some of the magnetic constituents in the feedstock are aligned with the applied field. After the alignment of the magnetic constituents, the shaped part may be sintered. In one form, the magnetic constituents may be made from a neodymium-iron-boron permanent magnet precursor material, as well as one or more rare earth ingredients.

### BACKGROUND OF THE INVENTION

The present invention relates generally to permanent magnets used for electric motors and their manufacture, and more particularly to methods for forming rare earth (RE) permanent magnets in substantially net shape without machining through the use of a modified metal injection molding (MIM) process.

Permanent magnets are used in a variety of devices, including DC electric motors for hybrid and electric vehicles, as well as wind turbines, air conditioning units and other applications where combinations of small volumes and high power densities may be beneficial. Sintered neodymium-iron-boron (Nd—Fe—B) permanent magnets with RE element additives such as dysprosium (Dy) or terbium (Tb) have desirable magnetic properties, where the substitution of Dy and/or Tb for Nd in Nd—Fe—B magnets results in increases of the anisotropy field and the intrinsic coercivity and a decrease of the saturation magnetization. In fact, the magnetic field produced by RE magnets can be an order of magnitude or more of conventional ferrite or ceramic magnets.

Despite the significant improvements in magnetic properties afforded by the use of Dy, Tb or related RE elements, their rarity and concomitant cost hampers their widespread use, as does the method of manufacture, where powder metallurgy or a related process is commonly used. By way of example, a typical magnet for a traction electric motor in a vehicular application may contain between about 6 and 10 weight percent of such additives to meet the required magnetic properties. Assuming the weight of permanent magnet pieces is about 1-1.5 kg per vehicular electric motor, and a yield of the machined pieces of typically about 55-65 percent, 2-3 kg of permanent magnets per motor would be required. Besides machining, other steps in conventional Nd—Fe—B permanent magnet production include weighing, pressing under a magnetic field, sintering and aging (this last step typically to about 5 to 30 hrs, at about 500° C. to 1100° C. in a vacuum). Additional surface treatments involving phosphating, electroless nickel plating, epoxy coating or the like may also be used.

Current sintered magnet technology has poor dimensional control, hence net shaped sintered magnets must be made by cutting and machining the magnet to its desired shape. Even simple shapes such as cylinders, squares or rectangles often involve some machining. As such, machining is a significant contributor to overall cost during a conventional magnet forming process, as significant amounts of Dy, Tb or related precious materials are removed from the final part. Machining is further problematic in that the magnetic properties of Nd—Fe—B sintered magnets are degraded when the magnet size is decreased because the machined surface introduces surface damage that provides nucleation sites for reversed magnetic domains. U.S. application Ser. No. 13/628,149, filed Sep. 27, 2012, entitled METHOD OF MAKING ND-FE-B SINTERED MAGNETS WITH REDUCED DYSPROSIUM OR TERBIUM, hereinafter referred to as the '149 application the contents of which is assigned to the assignee of the present invention and incorporated herein in its entirety by reference, describes a way to achieve varied surface concentrations of Dy or Tb in RE permanent magnets.

Metal Injection Molding (MIM) is a process which offers advantages over conventional production methods for parts with complex shapes that are produced in large quantities. With MIM, a feedstock that contains metal powder and a thermoplastic binder is injection molded, after which the binder is removed to allow the molded part to be subsequently sintered. MIM combines the benefits of shaping by injection molding with those of traditional powder metallurgy, where a metal powder is combined with a binder or lubricant, in a compression moldable preform for subsequent sintering. While traditional powder metallurgy processes are not suitable for the production of workpieces having complex geometric shapes, MIM permits virtually any component shape to be formed, and is particularly well-suited to the manufacture of small components.

Despite this, MIM does not account for the magnetic alignment of the powdered feedstock while it is being compacted. More particularly, in the absence of a magnetic field, an attempt to apply the MIM process to a feedstock containing magnetic powders will produce an isotropic (randomly oriented) magnet. For powders used in sintered magnets, such as those based on Nd—Fe—B or the like, the alignment that is essential to take full advantage of the material's magnetic properties has not been contemplated in conjunction with the MIM process.

### SUMMARY OF THE INVENTION

One aspect of the invention involves a method of making a permanent magnet that modifies the MIM process to take into consideration desirable magnetic alignment properties. In one embodiment, the method includes the application of an external magnetic field to magnetically align the metal powders or related precursors while they are being subjected to the injection molding process as a way to eliminate the need for expensive and wasteful machining operations. Significantly, using MIM allows any desirable magnet shape to be formed, where in a particular form, the powder particles used as the precursor may be prescreened to a desired size distribution prior to polymer coating for improved dimensional stability of the finished part. Furthermore, although Nd—Fe—B magnets are discussed throughout the present disclosure, the precursor magnet powder material may be of any other suitable formulations, including those that are based on ferrites, alnico (iron-based with aluminum, nickel and cobalt), samarium-cobalt or the like, so long as the resulting finished part has the necessary magnetic properties. Many of these suitable precursors also have irregular (i.e., non-round) powders that could benefit from the approaches discussed herein. Moreover, the present method is compatible with diffusion-enhanced techniques, such as grain boundary diffusion or other known techniques (such as chemical vapor deposition (CVD) or physical vapor deposition (PVD)) used to enhance Dy content that can further enhance coercivity or other desirable magnetic properties. Sintering is preferably performed in an inert environment (for example, gaseous nitrogen, argon or the like, between about 15 and 30 psi) to prevent oxidation and contamination so that magnet properties are not degraded. As mentioned in more detail below, one particular embodiment may permit reducing or eliminating the need for binders, where vibration-induced densification or compaction of the magnetic material introduced via MIM may be employed.

Another aspect of the present invention involves a method of making a permanent magnet by providing a magnetic material and a polymeric binder, combining them into a feedstock, conveying the feedstock to a mold that defines the shape of the finished part, applying a magnetic field to the feedstock in the mold in order to align at least a portion of the magnetic material and then sintering the shaped feedstock with the aligned magnetic materials. In one particular form, the magnet is made from a high anisotropy field and intrinsic coercivity material that also exhibits high saturation magnetization properties, such as Nd—Fe—B. In an even more particular form, such magnets may include RE additive elements such as Dy, Tb or the like.

Yet another aspect of the invention includes a method of making a permanent magnet motor. The method includes configuring at least one of a rotor and a stator to have permanent magnets disposed therein, where the magnets are made by combining a magnetic material and a polymeric binder into a feedstock, injection molding the feedstock in a mold to form it into a predetermined shape that corresponds to a complementary shape in the rotor or stator, and then applying a magnetic field to the feedstock at a location within the injection molding; this applied field preferentially aligns at least a portion of the magnetic material while the material is being molded (such as within a mold that is within the magnet field) and sintered into the predetermined shape. Optionally, the sintered magnet can later be surface treated to impart protective coating, as well as be treated for further magnetic property enhancement technique as needed. Later, the magnet could be placed into the complementary shape in the at least one rotor or stator, and then placing the rotor and the stator in rotational cooperation with one another such that upon the application of an electric current to the motor, the rotor rotates relative to the stator.

### BRIEF DESCRIPTION OF THE DRAWINGS

The following detailed description of the present invention can be best understood when read in conjunction with the following drawings, where like structure is indicated with like reference numerals and in which:

FIG. 1 is a schematic of a metal injection molding process that is used in conjunction with the present invention;

FIG. 2 shows is a simplified view of one aspect of the invention;

FIG. 3 shows is a simplified view of another aspect of the present invention and

FIG. 4 shows an exploded view of a permanent magnet motor for vehicular applications with magnets made according to the present invention.

### DETAILED DESCRIPTION OF THE PREFERRED EMBODIMENTS

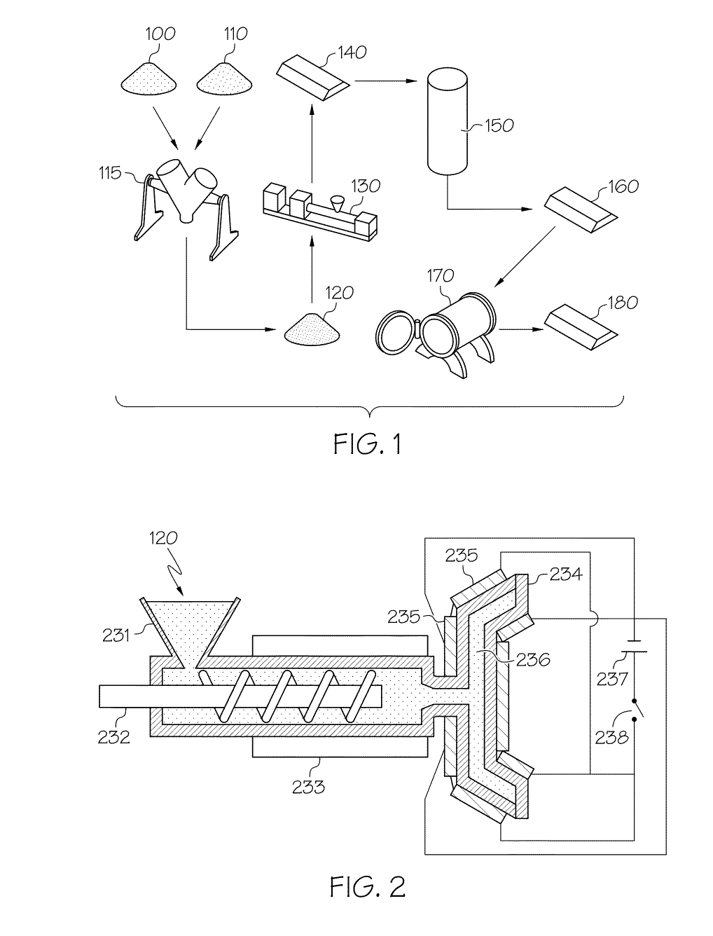

Referring first to FIG. 1, a current MIM process is shown. In it, metal powders (or material) 100 are mixed 115 with a suitable thermoplastic binder 110 to produce a homogeneous feedstock 120. The thermoplastic binder 110 helps ensure the consistent, repeatable shaping that is inherent in polymeric materials. The feedstock 120 is then introduced into an injection molding machine or apparatus 130 to form green part 140 with up to about 40 volume percent plastic binder. After this, the green part 140 is subjected to a solvent and thermal debinding operation 150 to remove the binder. Most of the binder 110 is removed at first chemically, whereas any residual (often referred to as “backbone” for its ability to keep the interim component together during injection molding) binder is then baked off via thermal removal. After this, the resulting component (referred to as a brown part 160) is in turn sintered 170 into a high density part or article 180 with the desired final shape, where a small amount of shrinkage leads to a substantially compact metal component.

The composition of the precursor materials determines the overall composition of the finished article 180 and is chosen according to the desired mechanical and magnetic properties. As stated above, Nd—Fe—B forms a suitable magnetic material precursor when in powdered or granular form. Likewise, the polymeric binder 110 (which may be made up of two or more polymeric components), is preferably in powder form to facilitate thorough mixing with he magnetic material precursor. The binder 110—which is used to speed up the mechanical alloying and coating process of the magnetic material precursor by helping to reduce the interface energy between the surfaces of the precursor powder that in turn increases the uniform wrapping or distribution of the surface powder, as well as to avoid surface powder clustering—may be in the form of a solvent, lubricant or the like. The solvent can be an alcohol, chlorinated solvent or commercially-available industrial solvent, as well as a solid lubricant such as boron nitride powder, molybdenum disulfide (MbS₂) powder or the like. Significantly, the present invention—with its emphasis on using an MIM process—allows net shaped magnets with better magnetic properties to be made in a less costly manner. Moreover, better material utilization is achieved due to elimination of grinding or machining operations.

In another embodiment, the feedstock 120 may rely on little (or no) polymeric binder 110, and instead may use a vibration technique (such as sonic or ultrasonic vibration) as a way to achieve a measure of feedstock 120 compaction. In this instance, once the magnetic material 100 is provided or otherwise introduced into the injection molding machine 130, subjecting it to vibrations or other binder-free compaction approaches can result in a densified component with a high degree of dimensional stability without any shrinkage from the subsequently-displaced binder 110. In one particular embodiment, the vibrations may be introduced into the feedstock-filled mold via speaker, transducer or the like. More particularly, the application of vibrations (whether acoustic, ultrasonic or the like) to the shaped magnet within the mold may be done to varying degrees. For example, it may be advantageous to avoid complete (or near-complete) compaction of the feedstock 120 in order to still allow the applied magnetic field to suitable rotate or otherwise align the magnetic material. Regardless, this approach may be beneficial in that it can shake or otherwise dislodge or rearrange the magnetic particles of the magnetic material 100 to give them more opportunity to rotate into the aligning direction of the applied magnetic field. In a preferred form, such agitation would take place while the external magnetic field is applied to maximize the chance of particle alignment. As mentioned above, such a vibration-based approach without the use of binders 110 would be especially beneficial to non-round powders. In any event, a combination of ultrasonic vibration and magnetic alignment would improve orientation for powders with higher non-round volume fraction, as well as reduce or eliminate the use of polymer binder for the present modified MIM process.

Although not shown, various other steps (some of which were not discussed above) may be used as part of a larger process to produce Nd—Fe—B (or related) permanent magnets. Such steps may include melting an initial alloy, casting it (such as by paddy cast, book mold cast, strip cast or the like), then subjecting it to a coarse crushing or milling operation. From this, various powder metallurgy steps may be used, such as pulverization or related fine milling, blending, pressing (such as by axial press, transverse press, isostatic press or the like), sintering or aging, sintering, heat treating and optional surface treatment, such as by coating (including electrocoating or the like). A further step, depending on the needs for placing the finished component into a particular configuration (such as a permanent magnet-based motor) may include magnetizing the material in situ, while in others, the part may be pre-magnetized.

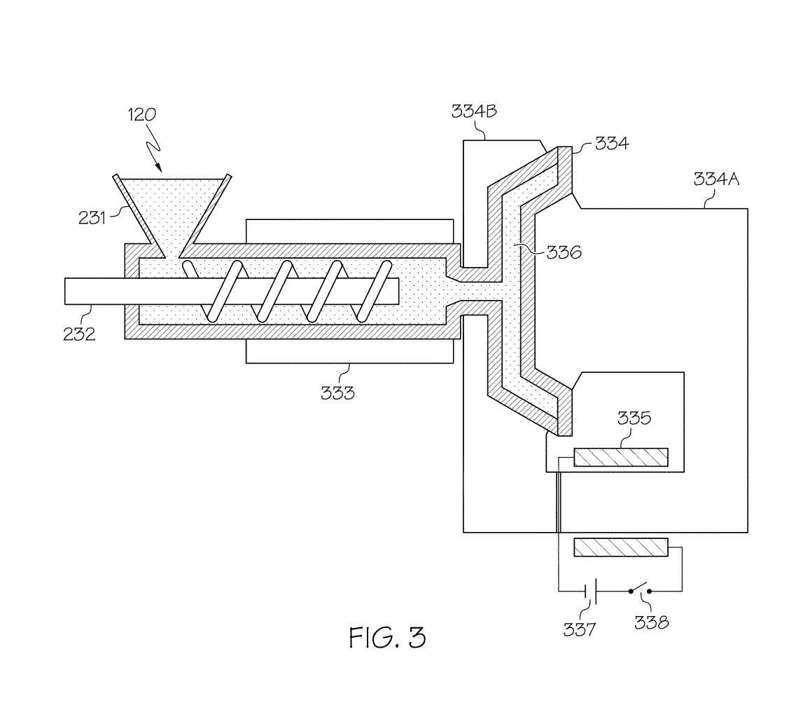

Referring next to FIGS. 2 and 3, two different ways to modify the MIM process of FIG. 1 is to allow for magnetic powder alignment in order to produce a fully oriented (i.e. anisotropic) compacted component 180 from the feedstock 120. In either form, the injection molding apparatus 130 is combined with a magnetizing fixture at or near its output. Magnetic powder precursor in the form of a blended or mixed feedstock 120 is placed in a hopper 231, 331 or other suitable receptacle and fed by a screw 232, 332 into a linear cavity along the screw's axial dimension. An optional heater 233, 333 may be used to raise the temperature of the feedstock 120 as it is fed into a mold 234, 334 formed at a distal (i.e., outlet) end of injection molding machine 230, 330.

In one form (shown with particularity in FIG. 2), this can be achieved by placing suitably configured magnetizing coils 235 around the flow channels 236 of the injection or compression mold machine 230. In this way, a magnetic field formed in the coils 235 is applied during the molding operation to the feedstock 120 as it flows through the mold 234 that is situated fluidly downstream of the injection molding machine 230. The applied field—which can be formed in magnetizing coils 235 via high current power supply 237 and actuated by switch 238—will force each powder particle to rotate during or after flow through the mold 234 so as to orient its magnetic axis along the applied field such that upon subsequent densification of the part, this orientation becomes permanently established. The placement, size and shape of the magnetizing coils 235 on the exterior of the mold 234 produces the desired magnetic field across the flow channels 236 that are formed in the desired final component shape within the mold 234. In an alternative to the coils 235, high current power supply 237 and switch 238, the magnetizing fixture may be made up of permanent magnets (not shown) placed about the chamber that defines the flow channels 236 and configured to produce the desired aligning magnetic field.

Referring with particularity to FIG. 3, an alternative approach to that of FIG. 2 includes using a soft magnet shunt that acts as a yoke or other magnetically-compliant device with coils 335. In one form, the shunt, made from a high permeability iron, iron-cobalt, or steel, can be used to apply the magnetic field across the mold 334. The flow channels 336 are thus surrounded by magnetizable yokes 334A and 334B such that electrical currents passing through wire coils wrapped around parts of the yokes 334A and 334B magnetize them and transmit the magnetic field through the flow channel 336 across the gap in the yokes 334A and 334B formed in the shunt. Alternatively, permanent magnets (not shown) may be incorporated into the yokes 334A and 334B to provide a large magnetic field. If the material making up the mold 334 is itself a magnetizable material, the magnetic field may be focused across suitable sections of the flow channels 336 by appropriately shaping the thickness of the mold 334 at various points along the channels 336. Thus, placing the soft magnet shunt adjacent to mold 334 that contains feedstock 120 and magnetizing the shunt by passing an electric current through wire coils placed around it allows the shunt to direct the magnetic field across the mold 334 such that the magnetic material within the feedstock 120 is aligned by the magnetic field. In another variation, permanent magnets and/or wound electrical coils can be incorporated into the walls of the mold itself.

Thus, FIG. 2 could take advantage of using permanent magnets attached to the mold to provide the aligning field, while FIG. 3 could take advantage of using permanent magnets within the shunt to provide the origin of the magnetic field transmitted to the mold 334 by the shunt. As stated above, while either coils 235 of FIG. 2 could be integrated into the mold 234, or permanent magnets embedded within the mold 234, another embodiment (not shown) could take advantage of suitable material and geometric features of the mold 234 to use the mold itself as part of the shunt of FIG. 3 to provide the desired aligning field configuration.

It is important to note that magnetic alignment is preferably accomplished during the molding operation, as alignment of the feedstock 120 prior to molding is not practical, as the particles will tend to rotate and misalign as they flow through the tortuous flowpath created by respective feedscrews 232, 332 and flow channels 236, 336. Moreover, because the operation of magnetic field-inducing equipment (such as power supply 237, 337 and switch 238, 338) involves significant expense, it may be advantageous to generate the magnetic field only once the feedstock 120 has been (or is about to be) introduced into the molds 234, 334, or even near or at the end of the flow process before curing the binder, in order to produce a more efficient alignment and compaction of multiple sets of parts, as well as reduce the costs associated with such field generation. Likewise, there can be little or no further relative motion of the powder particles in response to an applied magnetic field once the powder is fully densified and cured (such as occurs during sintering).

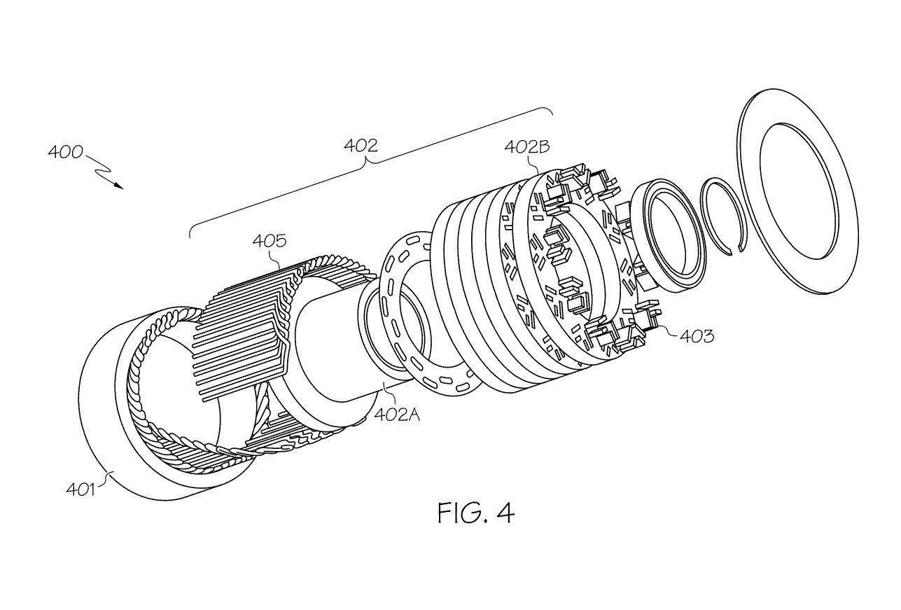

Referring next to FIG. 4, a permanent magnet DC motor 400 is shown in exploded view. Such a motor 400 may be used to provide traction power to a hybrid-powered (also known as a hybrid electric vehicle (HEV) or extended range electric vehicle (EREV) that is part of a larger class of vehicles referred to as electric vehicles (EVs)); such a motor 400 preferably cooperates with a fuel cell or a battery pack (neither of which are shown) to deliver propulsive power to the wheels of the vehicle. A traditional internal combustion engine (ICE, not shown) may also be used; such an engine may be directly coupled to a drivetrain to deliver power to the wheels, or may be coupled to motor 400 in order to convert shaft horsepower to electric power. Motor 400 includes a stator 401 that is typically made from a magnetically-compatable laminated material (for example, iron) concentrically placed about a rotor 402 that is made up of a hub 402A and laminated core 402B. Magnets 403 (similar to part 180 of FIG. 1) are formed around the periphery of rotor core 402B such that upon assembly of the rotor 402 with stator 401, the proximity of the magnets 403 with an electric current flowing through windings 405 that are supported by stator 401 to facilitate the electromagnetic interactions between them that in turn causes the rotor 402 to turn. Other structural components, such as a bearing support assembly and spacing rings or plates, are also shown. In an alternate configuration (not shown) of the device depicted in FIG. 4, the permanent magnets 405 may, instead of being formed in rotor 402, be formed in stator 401; it will be appreciated by those skilled in the art that either variant is suitable for use with the magnets 405 made in accordance with the present invention.

Details of a suitable sintering schedule useful for the present invention, as well as post-sintering heat treatment after sintering, may also be employed; representative sintering conditions and heat treatment are discussed in the '149 application.

As mentioned above, the feedstock 120 of the present invention may include small amounts of Dy or Tb in order to increase the performance of the magnets 403 of FIG. 4. Furthermore, the magnets 403 may be surface treated to prevent rusting or related oxidation. Examples of such surface treating may include phosphate, electroless Ni plating, aluminum physical vapor deposition (PVD), epoxy coating or related means.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. Likewise, a vehicle as understood in the present context includes numerous self-propelled variants, including a car, truck, aircraft, spacecraft, watercraft or motorcycle.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of making a permanent magnet, said method comprising:
using metal injection molding comprising:
providing a magnetic material;
providing a polymeric binder;
combining said magnetic material and said polymeric binder into a feedstock; and
injection molding said feedstock to form it into a predetermined shape;
applying a magnetic field to said feedstock in order to align at least a portion of said magnetic material; and
sintering said predetermined shape.

2. The method of claim 1, wherein the at least one magnetic material contains neodymium, iron and boron.

3. The method of claim 2, wherein the at least one magnetic material further contains at least one of dysprosium and terbium.

4. The method of claim 1, wherein said combining comprises mixing powdered forms of said magnetic material and said polymeric binder.

5. The method of claim 1, wherein said sintering takes place in a protective environment.

6. The method of claim 1, wherein said applying a magnetic field to said feedstock comprises placing magnetizing coils adjacent a mold that contains said feedstock, and passing an electric current through said magnetizing coils.

7. The method of claim 6, wherein said coils are embedded into said mold.

8. The method of claim 6, wherein said mold is constructed of soft magnetic material configured to direct said magnetic field across a space within said mold that holds said feedstock.

9. The method of claim 1, wherein said applying a magnetic field to said feedstock comprises placing a soft magnet shunt adjacent a mold that contains said feedstock, and magnetizing said shunt by passing an electric current through wire coils placed in electromagnetic cooperation therewith.

10. The method of claim 1, wherein said applying a magnetic field to said feedstock comprises placing a soft magnet shunt adjacent a mold that contains said feedstock, and incorporating at least one permanent magnet within said shunt to magnetize said shunt.

11. The method of claim 10, wherein said permanent magnets are embedded into said mold.

12. The method of claim 1, wherein said applying a magnetic field to said feedstock comprises placing permanent magnets adjacent a mold that contains said feedstock.

13. The method of claim 1, further comprising heating said feedstock during said injection molding.

14. The method of claim 1, wherein said permanent magnet defining said predetermined shape is achieved without any machining.

15. A method of making a permanent magnet, said method comprising:
providing a magnetic material;
providing a polymeric binder;
combining said magnetic material and said polymeric binder into a feedstock;
conveying said feedstock to a mold that defines a predetermined magnet shape;
applying a magnetic field to said feedstock in said mold in order to align at least a portion of said magnetic material; and
sintering said predetermined shape.

16. The method of claim 15, wherein said applying said magnetic field takes place after said feedstock has been received into said mold.

17. The method of claim 15, wherein said applying said magnetic field substantially coincides with the introduction of said feedstock into said mold.

18. The method of claim 15, wherein said conveying said feedstock to a mold is by metal injection molding.

19. A method of making a permanent magnet motor, said method comprising:
configuring at least one of a rotor and a stator of said motor to have permanent magnets disposed therein, said configuring comprising:
combining a magnetic material and a polymeric binder into a feedstock;
injection molding said feedstock to form it into a predetermined shape in a mold that corresponds to a complementary shape in said at least one rotor or stator;
applying a magnetic field to said feedstock in said mold in order to align at least a portion of said magnetic material;
sintering said predetermined shape; and
placing said sintered magnet into said complementary shape in said at least one rotor or stator; and
placing said rotor and said stator in rotational cooperation with one another such that upon the application of an electric current to said motor, said rotor rotates relative to said stator.

20. The method of claim 19, wherein said injection molding comprises metal injection molding.
